(19) United States
(12) Patent Application Publication
(10) Pub. No.: US 2026/0105284 A1
(43) Pub. Date: Apr. 16, 2026

(54) COMPUTING METHOD FOR A CONVOLUTIONAL NEURAL NETWORK AND DEVICE PERFORMING THE SAME

(71) Applicant: SAMSUNG ELECTRONICS CO., LTD., Suwon-si (KR)

(72) Inventors: Haonan FENG, Shaanxi (CN); Yutao LI, Shaanxi (CN); Shuaijun WU, Shaanxi (CN); Yili WANG, Shaanxi (CN); Kaige MA, Shaanxi (CN)

(73) Assignee: SAMSUNG ELECTRONICS CO., LTD., Suwon-si (KR)

(21) Appl. No.: 19/334,308

(22) Filed: Sep. 19, 2025

(30) Foreign Application Priority Data
Oct. 12, 2024 (CN) 202411423795.7

(51) Int. Cl. G06N 3/0464

(52) U.S. Cl. CPC G06N 3/0464

(57) ABSTRACT

A computing method for a convolutional neural network performed by a first device may include executing a first convolution layer of the convolutional neural network to obtain a first convolution matrix, writing the first convolution matrix to a high bandwidth memory (HBM) of a second device, controlling the second device to perform an activation operation on the first convolution matrix in the HBM through a first activation layer following the first convolution layer to obtain a first activation matrix, in response to the first activation matrix being written to the HBM, controlling the second device to perform a pooling operation on the first activation matrix in the HBM through a first pooling layer following the first activation layer to obtain a first pooling matrix, and in response to the first pooling matrix being written to the HBM, executing a second convolution layer following the first pooling layer

### CROSS-REFERENCE TO RELATED APPLICATIONS

This application is based on and claims priority under 35 U.S.C. § 119 to Chinese Patent Application No. 202411423795.7, filed on Oct. 12, 2024, in the China National Intellectual Property Administration, the disclosure of which is incorporated by reference herein in its entirety.

### BACKGROUND

The present disclosure relates to a technical field of data computing, and more specifically, to a method for computing in a convolutional neural network and a device performing the method.

When a processor such as a central processing unit (CPU) or a graphics processing unit (GPU) performs computations for a convolutional network, a part of intermediate result data may need to be stored in a high bandwidth memory (HBM) because storage space of the processor is insufficient to store all the intermediate result data. This may require frequent interaction with the HBM to write and/or read the intermediate result data and thus slows down the computation speed of the convolutional neural network (e.g., training speed, inference speed, etc.). In addition, different layers in the convolutional neural network may have different levels of computing complexity. For example, a convolution layer is computationally intensive, while an activation layer and a pooling layer have simple computation logic. As a result, the performance of computationally intensive layers is generally slowed down by the simpler layers.

Therefore, improving the computational speed of the convolutional neural network is a critical issue to be solved by the present disclosure.

### SUMMARY

One or more embodiments of the present disclosure provide a computing method for a convolutional neural network and a device performing the computing method.

According to an aspect of the present disclosure, there is provided a computing method for a convolutional neural network performed by a first device. The computing method may include: executing a first convolution layer of the convolutional neural network to obtain a first convolution matrix; writing the first convolution matrix to a high bandwidth memory (HBM) of a second device; controlling the second device to perform an activation operation on the first convolution matrix in the HBM through a first activation layer following the first convolution layer to obtain a first activation matrix; in response to the first activation matrix being written to the HBM, controlling the second device to perform a pooling operation on the first activation matrix in the HBM through a first pooling layer following the first activation layer to obtain a first pooling matrix; and in response to the first pooling matrix being written to the HBM, executing a second convolution layer following the first pooling layer, wherein the first convolution layer, the first activation layer, the first pooling layer and the second convolution layer are sequentially cascaded in the convolutional neural network

According to another aspect of the present disclosure, there is provided a computing method for a convolutional neural network performed by a second device. The computing method may include: receiving, from a first device, a first convolution matrix obtained by executing a first convolution layer of the convolutional neural network by the first device; storing the first convolution matrix in a high bandwidth memory (HBM) of the second device; in response to receiving a first control message from the first device, performing an activation operation on the first convolution matrix in the HBM through a first activation layer following the first convolution layer to obtain a first activation matrix, wherein the first control message is generated based on the first convolution matrix being written to the HBM by the first device; in response to receiving a second control message from the first device, performing a pooling operation on the first activation matrix in the HBM through first pooling layer following the first convolution layer to obtain a first pooling matrix, wherein the second control message is generated in response to the first activation matrix being written to the HBM by the first device; and writing the first pooling matrix to the HBM, wherein the first pooling matrix in the HBM is used by the first device for performing a convolution operation on the first pooling matrix based on a second convolution layer of the convolutional neural network, wherein the first convolution layer, the first activation layer, the first pooling layer and the second convolution layer are sequentially cascaded in the convolutional neural network.

According to another aspect of the present disclosure, there is provided a first device for performing a computing method using a convolutional neural network. The first device may include at least one processor configured to: execute a first convolution layer of the convolutional neural network to obtain a first convolution matrix; write the first convolution matrix to a high bandwidth memory (HBM) of a second device; control the second device to perform an activation operation on the first convolution matrix in the HBM through a first activation layer following the first convolution layer to obtain a first activation matrix; control the second device to perform a pooling operation on the first activation matrix in the HBM through a first pooling layer following the first convolution layer to obtain a first pooling matrix, in response to the first activation matrix being written into the HBM; and in response to the first pooling matrix being written into the HBM, executing a second convolution layer following the first pooling layer, wherein the first convolution layer, the first activation layer, the first pooling layer and the second convolution layer are sequentially cascaded in the convolutional neural network.

According to another aspect of the present disclosure, there is provided a second device for performing a computing method using a convolutional neural network. The second device may include at least one processor configured to: receive a first convolution matrix obtained by executing a first convolution layer of the convolutional neural network by the first device, a first control message and a second control message from the first device; in response to receiving the first control message, perform an activation operation on the first convolution matrix in a high bandwidth memory (HBM) of the second device, through a first activation layer following the first convolution layer to obtain a first activation matrix; in response to receiving the second control message, perform a pooling operation on the first activation matrix in the HBM through a first pooling layer following the first convolution layer to obtain a first pooling matrix; and store the first convolution matrix and the first pooling matrix in the HBM. The first pooling matrix in the HBM is used by the first device for performing a convolution operation on the first pooling matrix based on a second convolution layer of the convolutional neural network. The first convolution layer, the first activation layer, the first pooling layer, and the second convolution layer are sequentially cascaded in the convolutional neural network.

### BRIEF DESCRIPTION OF DRAWINGS

The above and other purposes and features of the present disclosure will become more apparent through the following descriptions made in conjunction with the figures schematically illustrating the embodiments, in which:

FIG. 1 illustrates a schematic diagram of a process for recognizing the number 4 in an image according to one or more embodiments;

FIG. 2 illustrates a schematic diagram of an example of a method of performing computing of a convolutional neural network in the related art;

FIG. 3 illustrates a flowchart of a computing method for a convolutional neural network according to one or more embodiments of the present disclosure;

FIG. 4 is a schematic diagram illustrating an example of partitioning of a convolution matrix, an activation operation of an activation layer, and a pooling operation of a pooling layer according to one or more embodiments of the present disclosure;

FIG. 5 illustrates a schematic diagram for comparing activation operations of related technology and activation operations according to one or more embodiments of the present disclosure;

FIG. 6 illustrates a flowchart of a computing method of a convolutional neural network according to one or more embodiments of the present disclosure;

FIG. 7 illustrates a schematic diagram of a control flow of a computing method for a convolutional neural network according to one or more embodiments of the present disclosure;

FIG. 8 illustrates a schematic diagram of a data flow corresponding to the embodiment in FIG. 7;

FIG. 9 is a block diagram illustrating a structure of a first device performing a computing method for a convolutional neural network according to one or more embodiments of the present disclosure; and

FIG. 10 is a block diagram illustrating a structure of a second device performing a computing method for a convolutional neural network according to one or more embodiments of the present disclosure.

### DETAILED DESCRIPTION

Hereinafter, various embodiments of the present disclosure are described with reference to the accompanying drawings, in which like reference numerals are used to depict the same or similar elements, features, and structures. However, the present disclosure is not intended to be limited by the various embodiments described herein to a specific embodiment and it is intended that the present disclosure covers all modifications, equivalents, and/or alternatives of the present disclosure, provided they come within the scope of the appended claims and their equivalents. The terms and words used in the following description and claims are not limited to their dictionary meanings, but, are merely used to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms include plural forms, unless the context clearly dictates otherwise. The terms “include,” “include,” and “have”, used herein, indicate disclosed functions, operations, or the existence of elements, but does not exclude other functions, operations, or elements.

For example, the expressions “A or B,” or “at least one of A and/or B” may indicate A and B, A, or B. For instance, the expression “A or B” or “at least one of A and/or B” may indicate (1) A, (2) B, or (3) both A and B.

In various embodiments of the present disclosure, it is intended that when a component (for example, a first component) is referred to as being “coupled” or “connected” with/to another component (for example, a second component), the component may be directly connected to the other component or may be connected through another component (for example, a third component). In contrast, when a component (for example, a first component) is referred to as being “directly coupled” or “directly connected” with/to another component (for example, a second component), another component (for example, a third component) does not exist between the component and the other component.

The expression “configured to”, used in describing various embodiments of the present disclosure, may be used interchangeably with expressions such as “suitable for,” “having the capacity to,” “designed to,” “adapted to,” “made to,” and “capable of”, for example, according to the situation. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are to describe certain embodiments of the present disclosure, but are not intended to limit the scope of other embodiments. Unless otherwise indicated herein, all terms used herein, including technical or scientific terms, may have the same meanings that are generally understood by a person skilled in the art. In general, terms defined in a dictionary should be considered to have the same meanings as the contextual meanings in the related art, and, unless clearly defined herein, should not be understood differently or as having an excessively formal meaning. In any case, even terms defined in the present disclosure are not intended to be interpreted as excluding embodiments of the present disclosure.

In order to facilitate the explanation of the present disclosure, the computing process for a convolutional neural network is firstly explained, and for ease of description, image recognition is illustrated as an example.

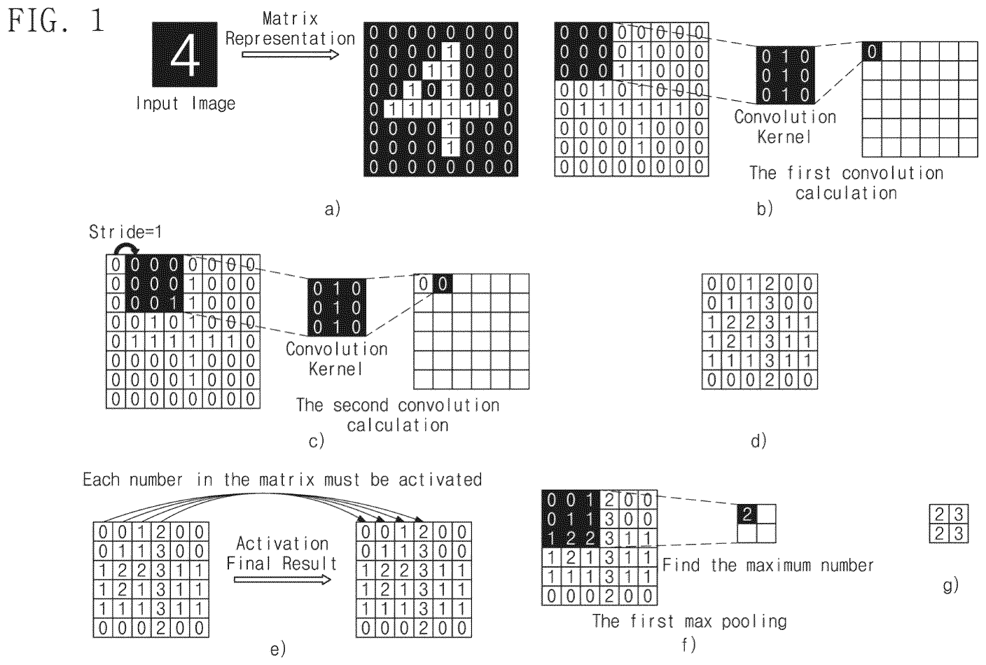

FIG. 1 illustrates a schematic diagram of the process of recognizing a number 4 in an image according to one or more embodiments.

Referring to a) in FIG. 1, assuming that the image may be represented by 8*8 pixels, in which the white pixels (i.e., the portion corresponding to the number 4) have a value of 1, and the black pixels have a value of 0. The values corresponding to the different regions of the image may be obtained, which may be represented in a form of a matrix.

Referring to b) in FIG. 1, a convolution operation may be performed on the matrix illustrated in a) based on a convolution layer. For example, the value 0 is obtained by performing a convolution operation on the 3*3 sub-matrix in the upper left corner of the matrix.

Referring to c) in FIG. 1, the next convolution operation may be performed by moving to the left in a step size set by the user, and a convolution result (which may also be referred to as a convolution matrix in this document) shown, for example, in d) in FIG. 1, may be finally obtained.

Then, an activation function may be used to activate all the elements in the convolution matrix to obtain an activation matrix based on the activation layer. The convolutional neural network may enhance the ability to learn complex features by using nonlinear functions as activation functions. For example, a Rectified Linear Unit (ReLU) function may be used as the activation function, which may be represented as follows:

$$y = \{ \begin{matrix}x & if x \geq 0 \\ 0 & if x < 0\end{matrix}$$

As illustrated in e) of FIG. 1, the activation matrix corresponding to the convolution matrix is obtained using the ReLU function.

After the activation matrix is obtained, a pooling operation may be performed on the activation matrix based on a pooling layer. The pooling operation is used to prevent the model from overfitting, and the max pooling method may be used. Referring to f) of FIG. 1, a pooling matrix as illustrated in g) of FIG. 1 may be obtained based on the max pooling. For example, values 2 and 3 are obtained as a result of performing a first max pooling and a fourth max pooling, respectively.

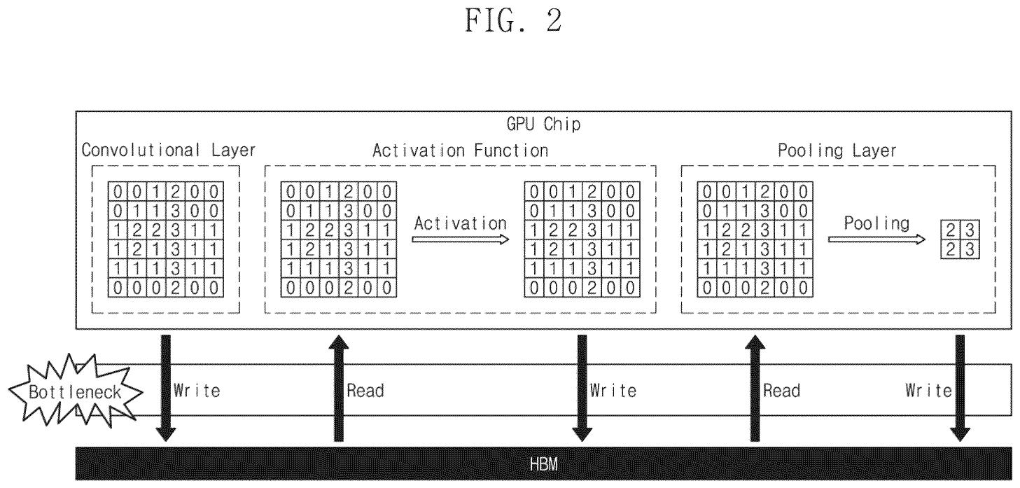

FIG. 2 illustrates a schematic diagram of an example of a method of performing a computing of a convolutional neural network in the related art.

Referring to FIG. 2, a GPU or GPU chip writes the computation result of a convolution layer to an HBM, and the computation result of the convolution layer is read from the HBM so as to be used in performing an activation function. The computation result of the activation function is written to the HBM, and the computation result of the activation function is read to the GPU chip so as to be used in performing a pooling operation of a pooling layer. The computation result of the pooling operation is written to the HBM. Additionally, although not shown in FIG. 2, when the computation result of the pooling layer is used in the next layer of the pooling layer (e.g., another convolution layer or a fully connected layer), the computation result of the pooling layer needs to be read from the HBM to the GPU chip to perform corresponding computations.

As can be seen, during the computing of the convolutional neural network, the GPU chip needs to interact with the HBM for frequent data reads, which obviously slows down the computing speed of the convolutional neural network, and thus leads to a bottleneck in computing speed.

The computing method for a convolutional neural network according to one or more embodiments of the present disclosure, may offload a layer with simpler computing logic to other computing devices to reduce the interaction of the processor with the HBM and increase the overall computing speed of the convolutional neural network.

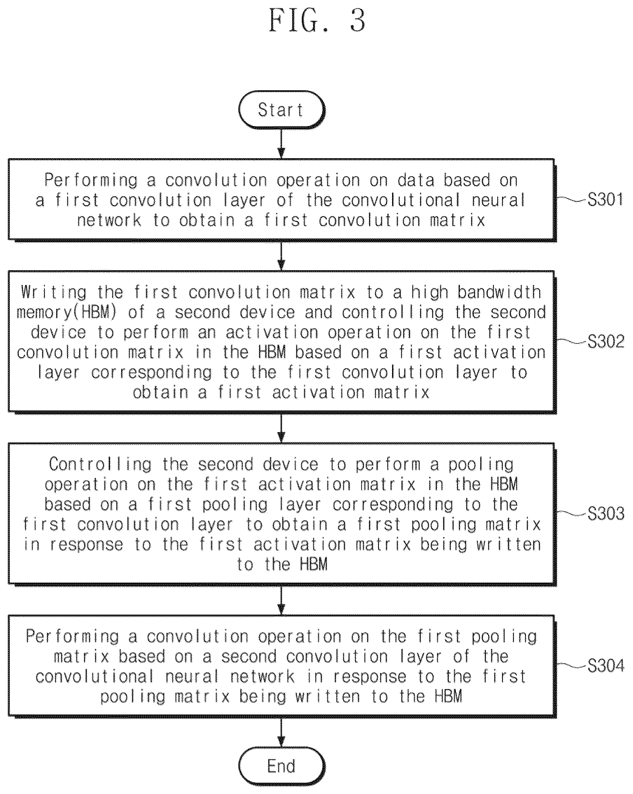

FIG. 3 illustrates a flowchart of a computing method for a convolutional neural network performed by a first device according to embodiments of the present disclosure.

Referring to FIG. 3, in operation S301, the first device executes a first convolution layer of the convolutional neural network to perform a convolution operation to obtain a first convolution matrix.

As understood by those skilled in the art, performing the convolution operation based on the first convolution layer of the convolutional neural network may denote performing the convolution operation on a data matrix (e.g., the matrix shown in FIG. 1 a)) using the first convolution layer to obtain the convolution matrix.

As an example, the data may be a matrix representing an image or other matrix to be processed by the convolutional neural network.

As an example, the first device may be a GPU, a CPU, and the like. The first device may include a computing core and a memory, wherein the computing core performs computing functions. For example, the GPU chip or GPU may include registers, shared memory, and local memory as memory.

In operation S302, the first convolution matrix is written to the HBM of the second device. The first device may control the second device to perform an activation operation on the first convolution matrix in the HBM based on a first activation layer corresponding to the first convolution layer to obtain a first activation matrix.

The first activation layer may be the next layer of the first convolution layer connected to the first convolution layer.

In the related art (e.g., the example described in FIG. 2), the computation for the activation layer is performed at a first device (i.e., a GPU), while embodiments of the present disclosure offload the activation layer of the convolutional neural network to a second device to perform the computation, which is capable of reducing the data reading interaction between the first device and the second device.

As an example, an activation function corresponding to the first activation layer may be a ReLU function.

As an example, the second device may be an HBM-PIM device. The HBM-PIM device may refer to a hardware architecture that integrates an AI-specific semiconductor in its HBM, and such technique is referred to as processing in memory (PIM). The HBM-PIM device may include processing units incorporated within the HMB. This technology integrates a dedicated data processor directly into the DRAM to transfer a portion of the data computing work from a host processor to the memory, which may reduce the movement of data to improve energy efficiency and data processing efficiency.

In operation S303, in response to the first activation matrix being written to the HBM, the first device may control the second device to perform a pooling operation on the first activation matrix in the HBM based on a first pooling layer corresponding to the first convolution layer to obtain a first pooling matrix.

The pooling layer may be the next layer of the activation layer connected to the activation layer.

In the related art (e.g., the example described in FIG. 2), the computing of the pooling layer is performed at a first device (i.e., a GPU), while embodiments of the present disclosure offload the pooling layer of the convolutional neural network to a second device to perform the computing, which is able to reduce the data read interaction between the first device and the second device. As an example, the pooling layer may use max pooling.

As an example, the method illustrated in FIG. 3 may further include: dividing the first convolution matrix into a plurality of partitions and/or dividing the first activation matrix into a plurality of partitions.

As an example, the controlling of the second device to perform the activation operation on the first convolution matrix in the HBM based on the first activation layer corresponding to the first convolution layer may include controlling the second device to perform the activation operation on the first convolution matrix according to the partitions, and/or the controlling of the second device to perform the pooling operation on the first activation matrix in the HBM based on the first pooling layer corresponding to the first convolution layer may include performing the pooling operation on the first activation matrix according to the partitions.

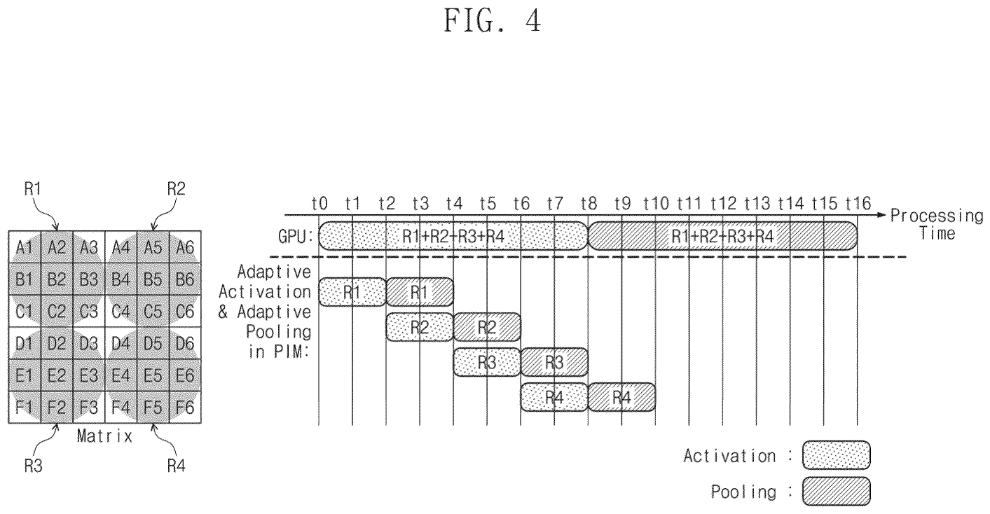

FIG. 4 is a schematic diagram illustrating an example of partitioning of a convolution matrix, an activation operation of an activation layer, and a pooling operation of a pooling layer according to one or more embodiments of the present disclosure.

Referring to FIG. 4, the convolution matrix may be divided into four partitions R1, R2, R3, and R4. From the perspective of the entire convolution matrix, R1, R2, R3, and R4 may be referred to as partitions. From the perspective of the individual elements of the convolution matrix, R1, R2, R3, and R4 may be referred to as groups, with each group containing multiple elements of the convolution matrix.

In an embodiment, a row-by-row activation strategy may be used by the GPU in performing an activation operation on the convolution matrix.

In other embodiments of the present disclosure, the second device performs activation on the convolution matrix according to the partitions.

For example, referring to FIG. 4, activation operations may be performed on partitions R1, R2, R3, and R4 sequentially. The activation operation according to partitions may increase the computing speed of the activation layer as compared to the activation by rows.

As an example, the controlling of the second device to perform the activation operation on the first convolution matrix according to partitions may include performing the activation operation on the plurality of partitions of the first convolution matrix in parallel, and/or, the controlling of the second device to perform the pooling operation on the first activation matrix according to partitions may include performing the pooling operation on the plurality of partitions of the first activation matrix in parallel. That is, when performing the activation operation or pooling operation, parallel processing is performed with respect to the partitions. The parallel processing can improve the speed of computing.

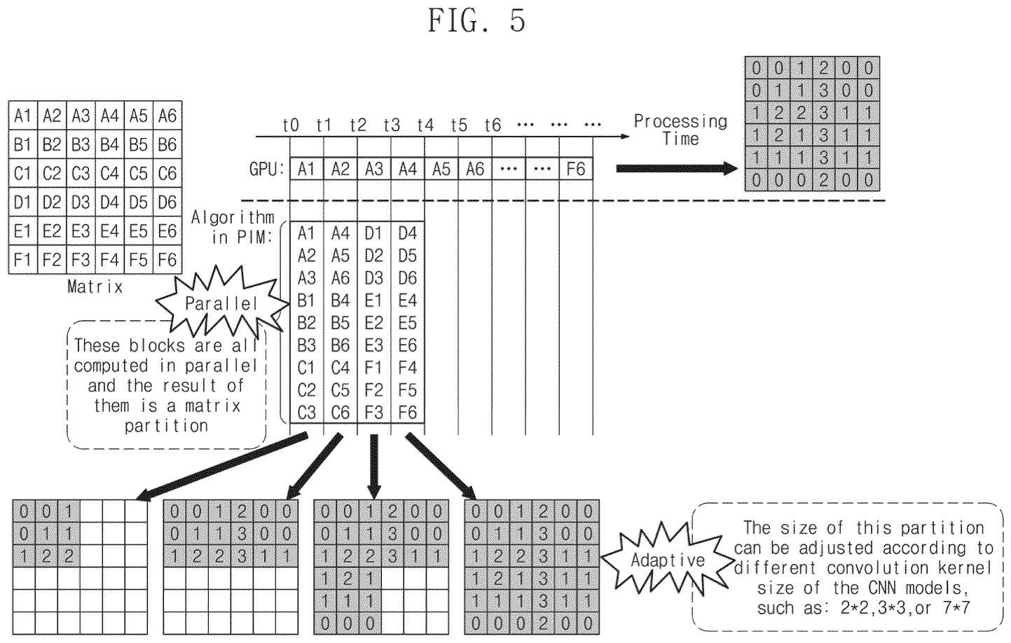

FIG. 5 illustrates a comparative schematic diagram of activation operations of related technology and activation operations of embodiments of the present disclosure.

Referring to FIG. 5, when the GPU performs the activation operation on the convolution matrix, a row-by-row activation strategy is used, while a plurality of elements in the convolution matrix are activated and process in parallel according to embodiments of the present disclosure. The activation operation according to embodiments of the present disclosure requires for less activation processing time than the GPU-based row-by-row activation operation. In one or more embodiments of the present disclosure, all elements of the convolution matrix may be processed in the PIM. Alternatively, some elements may be processed in the GPU, while the remaining elements are processed in the PIM.

As an example, the controlling of the second device to perform the pooling operation on the first activation matrix in the HBM based on the first pooling layer corresponding to the first convolution layer may include controlling the second device to perform the pooling operation on data of the first activation matrix that has been written to the HBM while the second device is being controlled to perform the activation operation on the first convolution matrix.

According to embodiments of the present disclosure, the pooling operation of the pooling layer may be performed when the activation operation is not fully completed. For example, returning to refer to FIG. 4, during the execution of the activation of partition R2 after the completion of the activation of partition R1, the pooling corresponding to partition R1 may be executed, that is, the pooling operation is executed on the activation elements corresponding to partition R1. Obviously, since the pooling operation does not need to wait for the activation operation to be fully completed, the efficiency of activation and pooling may be improved.

In operation S304, in response to the first pooling matrix being written to the HBM, a convolution operation is performed on the first pooling matrix based on a second convolution layer of the convolutional neural network, wherein the first convolution layer, the first activation layer, the first pooling layer, and the second convolution layer are sequentially cascaded in the convolutional neural network.

As an example, the performing of the convolution operation on the first pooling matrix based on the second convolution layer of the convolutional neural network in response to the first pooling matrix being written to the HBM may include performing the convolution operation on the first pooling matrix based on the second convolution layer of the convolutional neural network in response to data of the first pooling matrix having a size of a convolution kernel of the second convolution layer being written to the HBM.

According to embodiments of the present disclosure, the convolution operation of the second convolution layer is performed when a part of the pooling is completed, and accordingly it does not need to wait until all of the pooling operation is completed before performing the computation of the second convolution layer, which obviously improves the computing speed of the convolutional neural network.

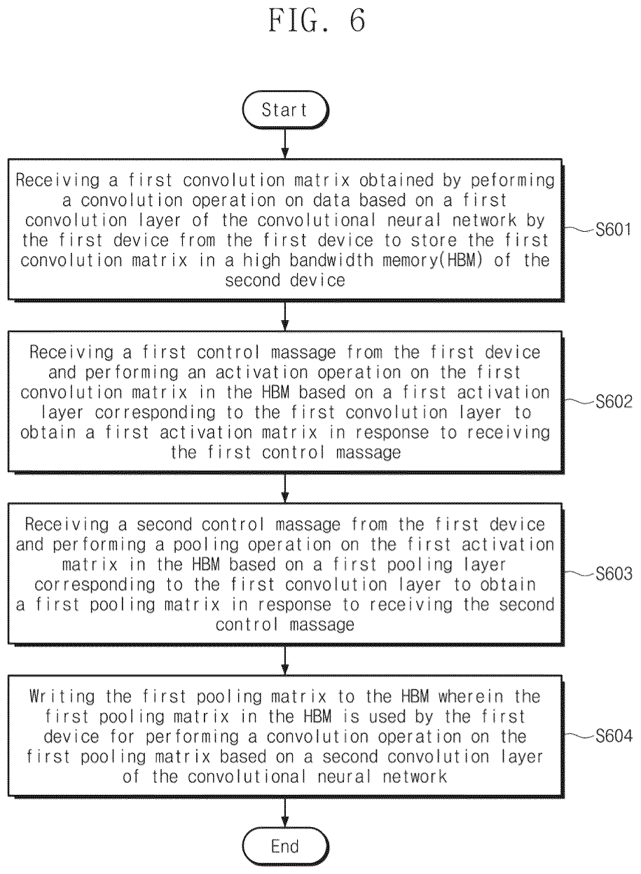

FIG. 6 illustrates a flowchart of a computing method for a convolutional neural network performed by a second device according to embodiments of the present disclosure.

Referring to FIG. 6, in operation S601, a first convolution matrix obtained by performing a convolution operation on data based on a first convolution layer of the convolutional neural network by the first device is received from the first device to store the first convolution matrix in an HBM of the second device.

In operation S602, a first control message is received from the first device and an activation operation on the first convolution matrix in the HBM is performed based on a first activation layer corresponding to the first convolution layer to obtain a first activation matrix in response to receiving the first control message. The first control message is generated based on the first convolution matrix being written to the HBM by the first device.

In operation S603, a second control message is received from the first device and the second device is controlled to perform a pooling operation on the first activation matrix in the HBM based on a first pooling layer corresponding to the first convolution layer to obtain a first pooling matrix in response to receiving the second control message. The second control message is generated in response to the first activation matrix being written to the HBM by the first device.

In operation S604, the first pooling matrix is written to the HBM, wherein the first pooling matrix in the HBM is used by the first device for performing a convolution operation on the first pooling matrix based on a second convolution layer of the convolutional neural network. The first convolution layer, the first activation layer, the first pooling layer and the second convolution layer are sequentially cascaded in the convolutional neural network.

As an example, the first convolution matrix is divided into a plurality of partitions by the first device and/or the first activation matrix is divided into a plurality of partitions by the first device.

As an example, the performing of the activation operation on the first convolution matrix in the HBM based on the first activation layer corresponding to the first convolution layer includes performing the activation operation on the first convolution matrix according to the partitions, and/or, the performing of the pooling operation on the first activation matrix in the HBM based on the first pooling layer corresponding to the first convolution layer includes performing the pooling operation on the first activation matrix according to the partitions.

As an example, sizes of the partitions are determined based on a size of a convolution kernel of the first convolution layer of the convolutional neural network.

As an example, when data of the first pooling matrix having a size of a convolution kernel of the second convolution layer is written to the HBM, the convolution operation on the first pooling matrix is performed based on the second convolution layer of the convolutional neural network by the first device.

As an example, the performing of the pooling operation on the first activation matrix in the HBM based on the first pooling layer corresponding to the first convolution layer may include performing the pooling operation on data of the first activation matrix that has been written to the HBM while the activation operation is being performed on the first convolution matrix.

As an example, the performing of the activation operation on the first convolution matrix according to partitions may include performing the activation operation on the plurality of partitions of the first convolution matrix in parallel, and/or, the performing of the pooling operation on the first activation matrix according to partitions may include performing the pooling operation on the plurality partitions of the first activation matrix in parallel.

As an example, the first device is a GPU and the second device is an HBM-PIM device.

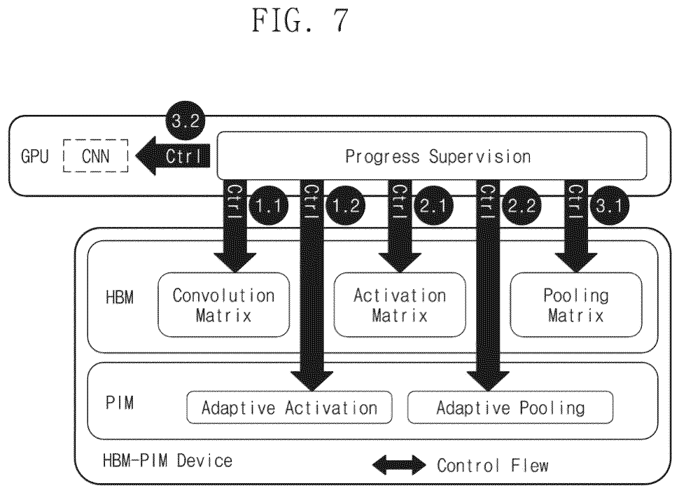

FIG. 7 illustrates a schematic diagram of a control flow of a computing method for a convolutional neural network according to embodiments of the present disclosure.

Referring to FIG. 7, the GPU may correspond to a first device described above, and the HBM-PIM device may correspond to a second device described above.

Referring to FIG. 7, the GPU may control storing and computing operations in the HBM-PIM based on a progress supervision module.

Specifically, in operation 1.1, the progress supervision module may supervise whether the convolution matrix is written to the HBM.

In operation 1.2, if the convolution matrix is written to the HBM, an adaptive activation layer is notified to start operation. The adaptive activation layer indicates the activation layer of the convolutional neural network that is offloaded to the HBM-PIM device. That is, the computing of the activation layer of the convolutional neural network is performed in the HBM-PIM device.

In operation 2.1, the progress supervision module may supervise whether the activation matrix is written to the HBM.

In operation 2.2, if the activation matrix is written to the HBM, the adaptive pooling layer is notified to start operation. The adaptive pooling layer described herein indicates the pooling layer of the convolutional neural network that is offloaded to the HBM-PIM device. That is, the computing of the pooling layer of the convolutional neural network is performed in the HBM-PIM device.

In operation 3.1, the progress supervision module may supervise whether the pooling matrix is written to the HBM.

In operation 3.2, when partial data (e.g., data with a size of the convolution kernel) of the pooling matrix is written to the HBM-PIM, the CNN is notified to perform computing for the next layer of the pooling layer.

According to embodiments of the present disclosure, when the CNN model is loaded into the GPU initially, the progress supervision module scans the CNN model and records relevant parameters, e.g., input data size, convolution kernel size, the number of network layers, etc. After obtaining the size of the convolution kernel, matrix partitioning may be performed based on the size of the convolution kernel, and the computing of the adaptive layer is based on the matrix partitioning.

As an example, sizes of the convolution kernels of different convolution layers may be the same or different. In one CNN model, sizes of the convolution kernels are generally the same for all convolution layers, and if the sizes are different, it may be clearly defined in the model. That is, each convolution layer has its own defined convolution kernel size.

As an example, the size of the convolution kernel of the first convolution layer is S1 (e.g., 5*5), then the size of the partition corresponding to the first convolution layer may be determined as S1. That is, when performing, for example, an activation on the computing result of the first convolution layer, the activation is performed according to the partition with a size of 5*5.

As an example, if the size of the convolution kernel of the second convolution layer (which will be described below) is S2 (e.g., 3*3), the size of the partition corresponding to the second convolution layer is determined as S2. That is, when performing, for example, an activation of the computing result of the second convolution layer, the activation is performed according to the partition with a size of 3*3.

In the computing of a convolutional neural network, the convolution kernel is the smallest unit of GPU computation, and thus dividing partitions according to the size of the convolution kernel is more conducive to GPU computation, thereby improve the speed of training or computation of the model.

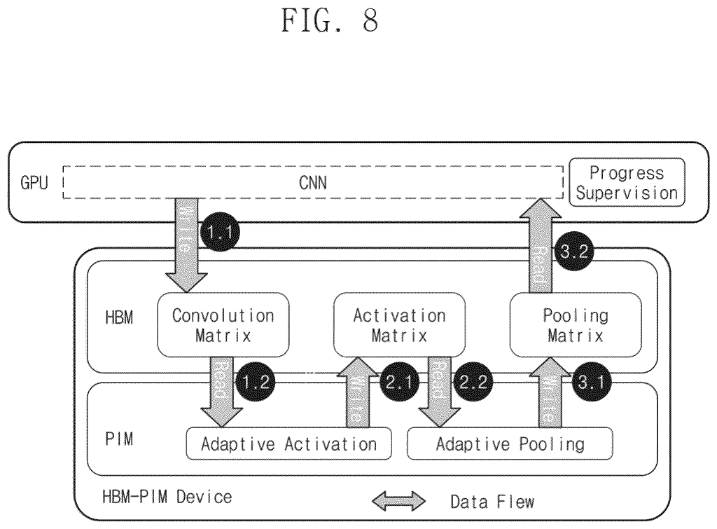

FIG. 8 illustrates a schematic diagram of a data flow corresponding to the embodiment in FIG. 7.

The data flow indicates read/write operations under the control flow.

Specifically, in operation 1.1, the CNN writes an intermediate result matrix (e.g., a convolution matrix) into the HBM.

In operation 1.2, the adaptive activation layer reads the convolution matrix from the HBM.

In operation 2.1, the adaptive activation layer writes the activation matrix into the HBM.

In operation 2.2, the adaptive pooling layer reads the activation matrix from the HBM.

In operation 3.1, the adaptive pooling layer writes the pooling matrix to the HBM.

In operation 3.2, the GPU reads the pooling matrix from the HBM to perform corresponding computing of the next layer of the pooling layer.

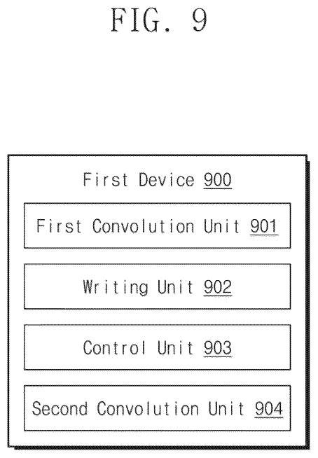

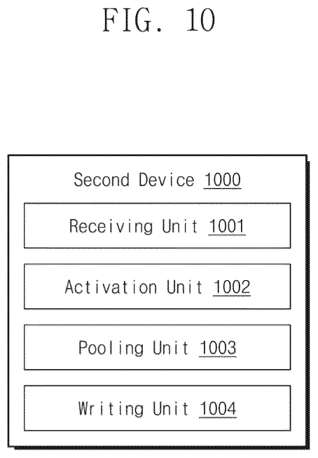

The computing method for the convolutional neural network according to embodiments of the present disclosure is described above with reference to FIGS. 1 to 8, and a device performing computing method for the convolutional neural network according to embodiments of the present disclosure is described below with reference to FIGS. 9-10.

FIG. 9 is a block diagram illustrating a structure of a first device 900 performing a computing method for a convolutional neural network according to embodiments of the present disclosure.

Referring to FIG. 9, the first device 900 may include a processor such as a GPU or a CPU, which includes a first convolution unit 901, a writing unit 902, a control unit 903, and a second convolution unit 904.

It should be understood by those skilled in the art that the first device 900 may additionally include other components, and that at least one of the components included in the first device 900 may be combined or divided.

As an example, the first convolution unit 901 may be configured to perform a convolution operation on data based on a first convolution layer of the convolutional neural network to obtain a first convolution matrix.

As an example, the writing unit 902 may be configured to write the first convolution matrix to a high bandwidth memory (HBM) of the second device.

As an example, the control unit 903 may be configured to control the second device to perform an activation operation on the first convolution matrix in the HBM based on a first activation layer corresponding to the first convolution layer to obtain a first activation matrix, and control the second device to perform a pooling operation on the first activation matrix in the HBM based on a first pooling layer corresponding to the first convolution layer to obtain a first pooling matrix in response to the first activation matrix being written into the HBM.

As an example, the second convolution unit 904 may be configured to perform a convolution operation on the first pooling matrix based on a second convolution layer of the convolutional neural network in response to the first pooling matrix being written into the HBM. The first convolution layer, the first activation layer, the first pooling layer and the second convolution layer are sequentially cascaded in the convolutional neural network.

As an example, the first device 900 may further include a dividing unit configured to divide the first convolution matrix into a plurality of partitions and/or divide the first activation matrix into a plurality of partitions.

As an example, the control unit 903 may be configured to control the second device to perform the activation operation on the first convolution matrix according to the partitions, and/or perform the pooling operations on the first activation matrix according to the partitions.

As an example, sizes of the partitions are determined based on a size of a convolution kernel of the first convolution layer of the convolutional neural network.

As an example, the second convolution unit 904 may be configured to perform the convolution operation on the first pooling matrix based on the second convolution layer of the convolutional neural network in response to data of the first pooling matrix having a size of a convolution kernel of the second convolution layer being written to the HBM.

As an example, the control unit 903 may be configured to control the second device to perform the pooling operation on data of the first activation matrix that has been written to the HBM while the second device is being controlled to perform the activation operation on the first convolution matrix.

As an example, the control unit 903 may be configured to control the second device to perform the activation operation on the plurality of partitions of the first convolution matrix based on the first activation layer corresponding to the first convolution layer in parallel, and/or, control the second device to perform the pooling operation on the plurality of partitions of the first activation matrix based on the first pooling layer corresponding to the first convolution layer in parallel.

As an example, the first device is a GPU and the second device is an HBM-PIM device.

FIG. 10 is a block diagram illustrating a structure of a second device 1000 performing a computing method for a convolutional neural network according to embodiments of the present disclosure.

Referring to FIG. 10, the second device 1000 may include a processor, and the processor may include a receiving unit 1001, an activation unit 1002, a pooling unit 1003, and a writing unit 1004.

It should be understood by those skilled in the art that the second device 1000 may additionally include other components, and that at least one of the components included in the second device 1000 may be combined or divided.

As an example, the receiving unit 1001 may be configured to receive a first convolution matrix obtained by performing a convolution operation on data based on a first convolution layer of the convolutional neural network by the first device, a first control message and a second control message from the first device.

As an example, the activation unit 1002 may be configured to perform an activation operation on the first convolution matrix in a high bandwidth memory (HBM) of the second device based on a first activation layer corresponding to the first convolution layer to obtain a first activation matrix in response to receiving the first control message.

As an example, the pooling unit 1003 may be configured to perform a pooling operation on the first activation matrix in the HBM based on a first pooling layer corresponding to the first convolution layer to obtain a first pooling matrix in response to receiving the second control message.

As an example, the writing unit 1004 may be configured to store the first convolution matrix in the HBM and write the first pooling matrix to the HBM. The first pooling matrix in the HBM is used for performing a convolution operation on the first pooling matrix based on a second convolution layer of the convolutional neural network by the first unit, the first convolution layer, the first activation layer, the first pooling layer and the second convolution layer are sequentially cascaded in the convolutional neural network.

As an example, the first convolution matrix may be divided into a plurality of partitions by the first device and/or the first activation matrix may be divided into a plurality of partitions by the first device.

As an example, the activation unit 1002 may be configured to perform the activation operation on the first convolution matrix according to the partitions, and/or, the pooling unit is configured to perform the pooling operation on the first activation matrix according to the partitions.

As an example, sizes of the partitions are determined based on a size of a convolution kernel of the first convolution layer of the convolutional neural network.

As an example, when data of the first pooling matrix having a size of a convolution kernel of the second convolution layer is written to the HBM, the convolution operation on the first pooling matrix is performed based on the second convolution layer of the convolutional neural network by the first device.

As an example, the pooling unit 1003 may be configured to perform the pooling operation on data of the first activation matrix that has been written to the HBM while the activation operation on the first convolution matrix is being performed.

As an example, the activation unit 1002 may be configured to perform the activation operation on the plurality of partitions of the first convolution matrix in parallel, and/or, the pooling unit 1003 may be configured to perform the pooling operation on the plurality of partitions of the first activation matrix in parallel.

As an example, the first unit is a GPU and the second unit is an HBM-PIM unit.

According to an embodiment of the present disclosure, there may be provided a computer-readable storage medium storing instructions, when executed by at least one processor, causing the at least one processor to perform the computing method for a convolutional neural network according to the present disclosure. Examples of computer-readable storage media here include: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, Compact Disc Read-Only Memory (CD-ROM), Compact Disc Recordable (CD-R), Compact Disc Digital Audio Recordable (CD+R), Compact Disc Rewritable (CD-RW), Compact Disc Digital Audio Rewritable (CD+RW), Digital Versatile Disc-ROM (DVD-ROM), DVD-Recordable (DVD-R), DVD Plus Recordable (DVD+R), DVD Rewritable (DVD-RW), DVD Plus Rewritable (DVD+RW), DVD-RAM, Blu-ray Disc ROM (BD-ROM), Blu-ray Disc Recordable (BD-R), Blu-ray Disc Recordable Long-Term High-Density (BD-R LTH), Blu-ray Disc Rewritable (BD-RE), Blu-ray or optical disc storage, hard disk drive (HDD), solid state Hard disk (SSD), card storage (such as multimedia card, secure digital (SD) card or extreme digital (XD) card), magnetic tape, floppy disk, magneto-optical data storage device, optical data storage device, hard disk, solid state disk and any other devices configured to store computer programs and any associated data, data files, and data structures in a non-transitory manner, and provide the computer programs and any associated data, data files, and data structures to the processor or the computer, so that the processor or the computer can execute the computer program. The computer program in the above-mentioned computer-readable storage medium may run in an environment deployed in computing equipment such as a client, a host, an agent device, a server, etc. In addition, in one example, the computer program and any associated data, data files and data structures are distributed on networked computer systems, so that computer programs and any associated data, data files, and data structures are stored, accessed, and executed in a distributed manner through one or more processors or computers.

According to an embodiment of the present disclosure, there may be provided a computer program product, wherein instructions in the computer program product may be executed by a processor of a computer device to implement the computing method for a convolutional neural network described herein.

Those skilled in the art will easily think of other embodiments of the present disclosure after considering the specification and practicing the disclosure disclosed herein. The present disclosure is intended to cover any variations, uses, or adaptive changes of the present disclosure. These variations, uses, or adaptive changes follow the general principles of the present disclosure and include common knowledge or conventional technical means in the technical field that are not disclosed in the present disclosure. The specification and the embodiments are to be regarded as exemplary only, and the actual scope and spirit of the present disclosure are pointed out by the following claims.

1. A computing method for a convolutional neural network performed by a first device, the computing method comprising:
executing a first convolution layer of the convolutional neural network to obtain a first convolution matrix;
writing the first convolution matrix to a high bandwidth memory (HBM) of a second device;
controlling the second device to perform an activation operation on the first convolution matrix in the HBM through a first activation layer following the first convolution layer to obtain a first activation matrix;
in response to the first activation matrix being written to the HBM, controlling the second device to perform a pooling operation on the first activation matrix in the HBM through a first pooling layer following the first activation layer to obtain a first pooling matrix; and
in response to the first pooling matrix being written to the HBM, executing a second convolution layer following the first pooling layer,
wherein the first convolution layer, the first activation layer, the first pooling layer and the second convolution layer are sequentially cascaded in the convolutional neural network.

2. The computing method of claim 1, further comprising:
dividing either one or both of the first convolution matrix and the first activation matrix into a plurality of partitions.

3. The computing method of claim 2, wherein the controlling of the second device to perform the activation operation comprises:
controlling the second device to perform the activation operation on the first convolution matrix according to the plurality of partitions, or
wherein the controlling of the second device to perform the pooling operation comprises:
controlling the second device to perform the pooling operation on the first activation matrix according to the plurality of partitions.

4. The computing method of claim 2, wherein sizes of the plurality of partitions are determined based on a size of a convolution kernel of the first convolution layer of the convolutional neural network.

5. The computing method of claim 1, the executing of the second convolution layer comprises:
performing a convolution operation on the first pooling matrix through the second convolution layer in response to data of the first pooling matrix having a size of a convolution kernel of the second convolution layer being written to the HBM.

6. The computing method of claim 1, wherein the controlling of the second device to perform the pooling operation comprises:
controlling the second device to perform the pooling operation on data of the first activation matrix that has been written to the HBM while the second device is being controlled to perform the activation operation on the first convolution matrix.

7. The computing method of claim 3, wherein the controlling of the second device to perform the activation operation on the first convolution matrix comprises:
performing the activation operation on the plurality of partitions of the first convolution matrix in parallel, or
wherein the controlling of the second device to execute the first pooling layer comprises:
performing the pooling operation on the plurality of partitions of the first activation matrix in parallel.

8. The computing method of claim 1, wherein the first device is a graphics processing unit (GPU) and the second device is an HBM-processing in memory (PIM) device.

9. A computing method for a convolutional neural network performed by a second device, the computing method comprising:
receiving, from a first device, a first convolution matrix obtained by executing a first convolution layer of the convolutional neural network by the first device;
storing the first convolution matrix in a high bandwidth memory (HBM) of the second device;
in response to receiving a first control message from the first device, performing an activation operation on the first convolution matrix in the HBM through a first activation layer following the first convolution layer to obtain a first activation matrix, wherein the first control message is generated based on the first convolution matrix being written to the HBM by the first device;
in response to receiving a second control message from the first device, performing a pooling operation on the first activation matrix in the HBM through first pooling layer following the first convolution layer to obtain a first pooling matrix, wherein the second control message is generated in response to the first activation matrix being written to the HBM by the first device; and
writing the first pooling matrix to the HBM, wherein the first pooling matrix in the HBM is used by the first device for performing a convolution operation on the first pooling matrix based on a second convolution layer of the convolutional neural network,
wherein the first convolution layer, the first activation layer, the first pooling layer and the second convolution layer are sequentially cascaded in the convolutional neural network.

10. The computing method of claim 9, wherein either one or both of the first convolution matrix and the first activation matrix are divided into a plurality of partitions by the first device.

11. The computing method of claim 10, wherein the performing of the activation operation on the first convolution matrix in the HBM comprises:
performing the activation operation on the first convolution matrix according to the plurality of partitions,
wherein the performing of the pooling operation on the first activation matrix in the HBM comprises:
performing the pooling operation on the first activation matrix according to the plurality of partitions.

12. The computing method of claim 10, wherein sizes of the plurality of partitions are determined based on a size of a convolution kernel of the first convolution layer of the convolutional neural network.

13. The computing method of claim 9, wherein when data of the first pooling matrix having a size of a convolution kernel of the second convolution layer is written to the HBM, the convolution operation on the first pooling matrix is performed based on the second convolution layer of the convolutional neural network by the first device.

14. The computing method of claim 9, wherein the performing of the pooling operation on the first activation matrix in the HBM comprises:
performing the pooling operation on data of the first activation matrix that has been written to the HBM while the activation operation is being performed on the first convolution matrix.

15. The computing method of claim 11, wherein the performing of the activation operation on the first convolution matrix according to the plurality of partitions comprises:
performing the activation operation on the plurality of partitions of the first convolution matrix in parallel, or
wherein the performing of the pooling operation on the first activation matrix according to the plurality of partitions comprises:
performing the pooling operation on the plurality partitions of the first activation matrix in parallel.

16. The computing method of claim 9, wherein the first device is a GPU and the second device is an HBM-PIM device.

17. A first device for performing a computing method using a convolutional neural network, the first device comprising at least one processor configured to:
execute a first convolution layer of the convolutional neural network to obtain a first convolution matrix;
write the first convolution matrix to a high bandwidth memory (HBM) of a second device;
control the second device to perform an activation operation on the first convolution matrix in the HBM through a first activation layer following the first convolution layer to obtain a first activation matrix;
control the second device to perform a pooling operation on the first activation matrix in the HBM through a first pooling layer following the first convolution layer to obtain a first pooling matrix, in response to the first activation matrix being written into the HBM; and
in response to the first pooling matrix being written into the HBM, execute a second convolution layer following the first pooling layer,
wherein the first convolution layer, the first activation layer, the first pooling layer and the second convolution layer are sequentially cascaded in the convolutional neural network.

18. The first device of claim 17, wherein the at least one processor is further configured to divide either one or both of the first convolution matrix and the first activation matrix into a plurality of partitions.

19. The first device of claim 18, wherein the at least one processor is further configured to:
control the second device to perform the activation operation on the first convolution matrix according to the plurality of partitions, or
perform the pooling operations on the first activation matrix according to the plurality of partitions.

20. The first device of claim 18, wherein sizes of the partitions are determined based on a size of a convolution kernel of the first convolution layer of the convolutional neural network.

21.-33. (canceled)
